(19) United States
(12) Patent Application Publication
(10) Pub. No.: US 2003/0191684 A1
(43) Pub. Date: Oct. 9, 2003

(54) Personal experience analysis system

(75) Inventors: Jill A. Lumsden, Tallahassee, FL (US); Jeffrey W. Garis, Tallahassee, FL (US); Robert C. Reardon, Tallahassee, FL (US); Myrna P. Hoover, Crawfordville, FL (US); Janet G. Lenz, Tallahassee, FL (US); Juliette L. McDonald, Tallahassee, FL (US); Britton C. Powers, Tallahassee, FL (US); Scott S. Arkin, Tallahassee, FL (US)

Correspondence Address: FOLEY & LARDNER, 777 EAST WISCONSIN AVENUE, SUITE 3800, MILWAUKEE, WI, 53202-5308, US

(73) Assignee: The Florida State University Research Foundation

(21) Appl. No.: 10/118,745

(22) Filed: Apr. 8, 2002

(51) Int. Cl. G06F 17/60

(52) U.S. Cl. 705/11

(57) ABSTRACT

A system for presenting and analyzing personal accomplishments in an electronic environment provides a simple and efficient method for assessing any of a variety of experiences or accomplishments. The system includes a database storing personal accomplishment information and a skills analysis module in communication with the database. The skills analysis module is configured to provide a summary of the personal accomplishment information, wherein the summary comprises a list including a plurality of personal attributes and a summary of the personal accomplishment information corresponding to each of the personal attributes.

### CROSS-REFERENCE TO RELATED PATENT APPLICATIONS

This patent application is related to U.S. application Ser. No. ______ (Atty. Docket No. 053272-0102), by Lumsden et al., entitled “Portfolio Creation and Management System and Method” and U.S. application Ser. No. ______ (Atty. Docket No. 053272-0104), by Lumsden et al., entitled “Personal Information Presentation System and Method,” both filed on the same date as and assigned to the same assignee of this patent application.

### BACKGROUND OF THE INVENTION

The present invention relates generally to the field of electronic data systems. The present invention relates more specifically to the field of electronic career portfolio creation and management systems.

Students, job seekers, and other individuals may wish to present biographical information about themselves to third parties. For example, a student seeking an employment interview with a particular company may wish to provide the company with a resume, a cover letter, a writing sample, references, or other information. The student may also wish to provide other information related to particular accomplishments or experiences that may be particularly relevant to the employer either in summary form or in more extensive fashion. The sum of the biographical information provided by the student represents that student's personal portfolio, which may be intended by the student to serve any of a number of purposes.

Because an individual may have a variety of reasons for preparing a personal portfolio, the individual may wish to customize the portfolio for a particular purpose. Continuing the above example, the student may be seeking a job with an investment banking firm, applying for graduate school, and supplying still life photographs taken by the student to a magazine for publication, just to name a few possibilities. For each of these endeavors, the student may wish to emphasize different biographical information. The investment banking firm may not be interested in art classes the student took while an undergraduate, while an internship at the New York Stock Exchange may not be particularly relevant as far as the magazine is concerned. Tailoring the portfolio to its intended recipient may thus be critical to the success or failure of the student in a particular situation.

One difficulty in preparing a portfolio is that the necessary information is often scattered among a variety of locations. The student may keep an electronic copy of a resume on a personal computer, a sheet of paper listing various references in a file cabinet, and a transcript for classes taken in a desk drawer. In other situations, some or all of the necessary information may be missing or otherwise unavailable to the student when it is needed most.

Another difficulty is that an individual may not realize that certain aspects of their portfolio may need additional enhancement. For example, the student may have taken every course offered in a particular area, but work experience, projects, membership in societies or organizations, or other experiences may also be helpful to fully appreciate the particular area. A related difficulty is that students may be unaware of certain attributes, characteristics, or skills that employers or other third parties are looking for in a candidate. Attributes such as communication, creativity, critical thinking, and the like may be considered important. Certain employers may value some personal attributes more than others. For example, an investment banking firm may value critical thinking and technical knowledge more than creativity or social responsibility. Students faced with such employer preferences may wish to identify areas that need improvement early on so that appropriate measures may be taken to bolster their experiences and accomplishments in these areas.

Another difficulty is that producing a personal portfolio may be a complicated and involved project that takes a considerable amount of time. The busy student may not have time to prepare a new portfolio every time one is needed, and may simply prepare a single portfolio and use this regardless of the purpose. This may not be ideal for situations where a customized portfolio would better serve the student's goals.

Another difficulty is that once the portfolio is provided to the third party, the student or other individual may not know if the portfolio has been reviewed by the intended recipient. The student may wait for months to hear from the employer, only to find out that the portfolio had never arrived and that the job was given to another person who submitted the materials in a timely manner.

It would thus be advantageous to provide a system or method that provides a central location for all information that may be used to prepare a portfolio. It would also be advantageous to provide a system or method that allows an individual to assess past accomplishments and experiences in relation to particular goals, skills, or personal attributes. It would further be advantageous to provide a system or method that allows for increased efficiency in preparing and presenting personal portfolios. It would further be advantageous to provide a system or method that allows an individual to determine whether a particular portfolio has been reviewed by a recipient. It would further be advantageous to provide a system or method that allows an individual to assemble biographical information, prepare customized personal portfolios, provide access to the personal portfolios, and review accesses or viewings of the personal portfolios in an electronic environment.

It would be desirable to provide a system or method that accomplishes one or more of these or other advantageous features. Other features will be made apparent from the present specification. The teachings disclosed extend to those embodiments which fall within the scope of the appended claims, regardless of whether they accomplish one or more of the above-mentioned needs.

### SUMMARY OF THE INVENTION

One exemplary embodiment relates to a system for presenting and analyzing personal accomplishments in an electronic environment. The system includes a database storing personal accomplishment information and a skills analysis module in communication with the database and configured to provide a summary of the personal accomplishment information. The summary comprises a list including a plurality of personal attributes and a summary of the personal accomplishment information corresponding to each of the personal attributes.

Another exemplary embodiment relates to a system for presenting a summary of personal experience information. The system includes an electronic archive storing personal experience information and an information entry module enabling entry of the personal experience information into the electronic archive. The system also includes a module in communication with the electronic archive presenting a summary of the personal experience information at a display, the summary indicating the presence of personal experience information stored in the electronic archive corresponding to at least one personal attribute.

A further exemplary embodiment relates to a system for generating a summary of personal experience information. The system includes an information repository configured to retain personal experience information and means for inputting the personal experience information into the information repository. The system also includes a summary generator in data communication with the information repository for presenting a summary of at least a portion of the personal experience information. The summary is presented at a computing device as a grid that graphically indicates the presence of experience information in the information repository corresponding to a plurality of personal characteristics.

Other principal features and advantages will become apparent to those skilled in the art upon review of the following drawings, the detailed description, and the appended claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a schematic view of a portfolio creation and management system according to an exemplary embodiment;

FIG. 2 is a diagrammatic representation of a home page included in a portfolio module according to an exemplary embodiment;

FIG. 3 is a diagrammatic representation of a login screen included in the portfolio module;

FIG. 4 is a diagrammatic representation of a main menu page included in the portfolio module;

FIG. 5 is a diagrammatic representation of a skills and experience summary page included in the portfolio module;

FIG. 6 is a diagrammatic representation of a course information entry page included in the portfolio module;

FIG. 7 is a diagrammatic representation of a course record page included in the portfolio module;

FIG. 8 is a diagrammatic representation of an artifacts and examples page included in the portfolio module;

FIG. 9 is a diagrammatic representation of a portfolio customization page included in the portfolio module;

FIG. 10 is a diagrammatic representation of a skills ranking page included in the portfolio module;

FIG. 11 is a diagrammatic representation of a skills information selection page included in the portfolio module;

FIG. 12A is a diagrammatic representation of a first portion of an access key creation page included in the portfolio module;

FIG. 12B is a diagrammatic representation of a second portion of an access key creation page included in the portfolio module;

FIG. 13 is a diagrammatic representation of a personal profile displayed as part of a personal portfolio according to an exemplary embodiment;

FIG. 14 is a diagrammatic representation of a résumé displayed as part of the personal portfolio;

FIG. 15 is a diagrammatic representation of a skills list displayed as part of the personal portfolio;

FIG. 16 is a diagrammatic representation of a transcript displayed as part of the personal portfolio;

FIG. 17 is a diagrammatic representation of an artifacts and examples display page displayed as part of the personal portfolio;

FIG. 18 is a diagrammatic representation of a references page displayed as part of the personal portfolio;

FIG. 19 is a diagrammatic representation of an access detail page included in the portfolio module; and

FIG. 20 is a flow diagram illustrating a method of using the portfolio module according to an exemplary embodiment.

### DETAILED DESCRIPTION OF THE PREFERRED EMBODIMENTS

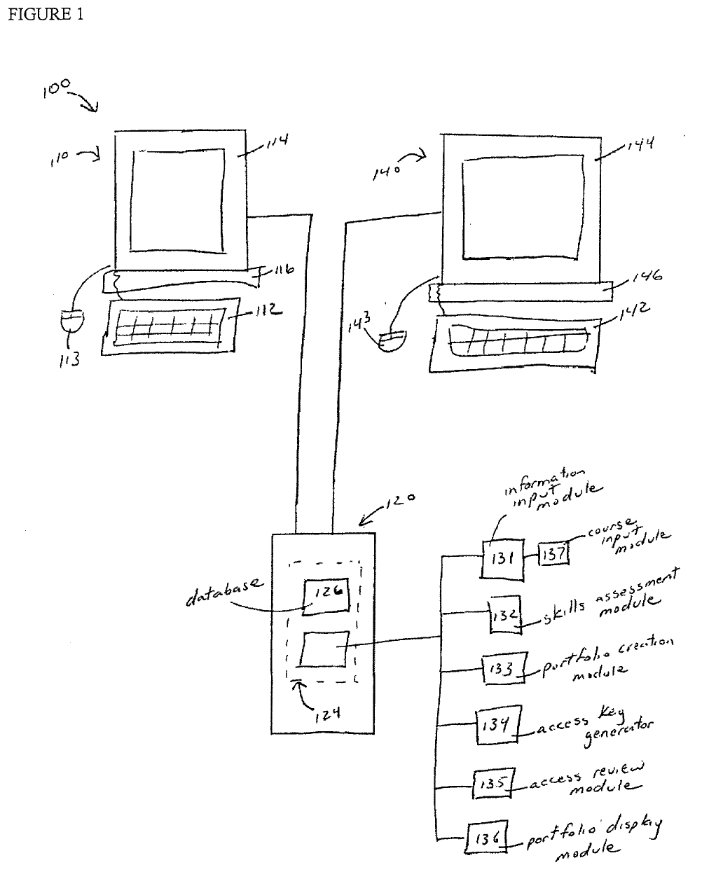

Referring to FIG. 1, a portfolio creation and management system 100 is shown according to an exemplary embodiment. One or more user computers or computing devices 110 and one or more third party or referred user computers or computing devices 140 are in electronic communication with a server or server computer 120. In an exemplary embodiment, a user such as a student, job applicant, employee, or the like may access a personal portfolio module 124 with user computer 110. The user may then create and/or modify individual portfolios that may include any of a variety of portfolio information relating to the user's experiences, accomplishments, and the like. A third party or referred user, such as a potential employer, school administrator, or the like, may also access portfolio creation and management system 100 to review portfolios created by one or more users.

As used throughout the following description, the terms “communicate” and “in communication with” refer to the transfer of electronic information or data between electronic devices such as user computer 110, server 120, and third party computer 140. This communication may occur over a wired or wireless connection, and may include transmission across a computer network, such as a local area network (LAN), wide area network (WAN), the Internet, an Intranet, or the like. Each of the connections between the various electronic devices may be referred to as an “electronic connection,” or a connection over which electronic information may be transferred.

As shown in the exemplary embodiment of FIG. 1, user computer 110 is a personal or general purpose computer. User computer 110 may include input devices such as a keyboard 112 and a mouse 113. A monitor or display 114 is provided to allow a user to view information presented thereon. Display 114 may be any type of display device, including a cathode ray tube (CRT) type monitor, a liquid crystal display (LCD), a plasma display, and the like. In alternative embodiments, the user computer may include any of a variety of input devices, including a microphone, roller ball, touch pad, light pen, or other device designed for inputting information into the user computer. Additionally, user computer 110 may be any of a variety of different types of computing devices. For example, the user computer may be a desktop computer, laptop or notebook computer, hand held computer, personal digital assistant, or the like.

User computer 110 also includes a case or shell 116 in which various components (not shown) of user computer 110 are contained. For example, case 116 may include a central processing unit or processor, a magnetic storage device such as a hard drive, one or more random access memory (RAM) chips, a CD-ROM drive, a DVD-ROM drive, a writeable or rewriteable CD-ROM or DVD-ROM drive, a floppy disk drive, a modem, an Ethernet or networking card, or any of a variety of other components.

As shown in the exemplary embodiment of FIG. 1, referred user computer 140 is also a general purpose computer that includes input devices such as a keyboard 142 and a mouse 143. A monitor or screen 144 is provided for allowing a referred user to view information presented thereon. Third party computer 140 also includes a case or shell 146 in which various components (not shown) of third party computer 140 are contained. As described above with respect to user computer 110, third party computer 140 may be any of a variety of different types of computing devices, and may include any of a variety of components. Third party computer 140 may be similar to or different from user computer 110. For example, a user computer may be a general purpose computer while a third party computer may be a personal digital assistant.

Server 120 may be any type of computing device capable of receiving, transmitting, and/or storing electronic information. In an exemplary embodiment, server 120 includes one or more relatively permanent storage devices or media (not shown) that act as relatively permanent repositories for information, such as a magnetic hard drive. The storage media may serve as a repository for completed and/or in-process portfolios. Alternatively, completed or in-process portfolios may be stored on user computer 110. The storage media may comprise magnetic, optical, tape, or other media designed to relatively permanently store electronic information or data. Server 120 also includes at least one central processing unit or processor and a temporary memory, which may include random access memory chips. Server 120 may also include a modem, Ethernet, or other networking card (not shown) for receiving and transmitting electronic information or data.

Included within server 120 is a personal portfolio module 124. Portfolio module 124 may be a computer program, a web page, an applet, a script, or the like, configured to allow the creation, management, access, and viewing of individual portfolios. A portfolio information database or repository 126 (e.g., an electronic archive) is provided for storing personal experience or accomplishment information that may be used to create individual portfolios.

A variety of modules 130 are included within portfolio module 124 to allow users and/or referred users to perform various functions. For example, an information entry or input module 131 allows a user to enter or input portfolio information relating to experiences, accomplishments, and the like. A skills analysis or assessment module 132 provides or displays portfolio information in either complete or summary format. Module 132 may alternatively be referred to as a summary or skills matrix generator. For example, skills assessment or analysis module 132 may provide a summary of portfolio information included in database 126 that includes a list of skills or attributes (e.g., creativity, leadership, etc.) and a list of experience or accomplishment types or categories (e.g., courses, jobs, activities, etc.). The summary may be provided at a display in a user computer or at a referred user computer. The user may then easily review past experiences and accomplishments in relation to the various attributes and experience types, as will be described in greater detail below. A portfolio creation or generation module 133 allows a user to create one or more personal portfolios using portfolio information included in database 126. For example, a user may create a variety of customized or individualized personal portfolios, each of which contains at least a portion of the portfolio information in database 126. The portfolio information included in each of the individual portfolios may be identical or may differ in substance or arrangement. For example, two different portfolios may include identical information, but certain information may be emphasized in one by listing that information first, where the same information may be de-emphasized in another portfolio by listing the information last. In another example, certain information may be included in one portfolio but excluded from another portfolio.

An access key module or generator 134 allows a user to create one or more access keys or codes corresponding to one or more personal portfolios. The access keys may act as a password or security device to ensure that only authorized referred users access a particular portfolio. In an exemplary embodiment, each portfolio may have associated with it one or more access keys. An access review module 135 allows a user to review access to or viewings of particular portfolios. For instance, access review module 135 may provide a table or chart listing each of the personal portfolios and information pertaining to the access of the portfolios by referred users, including the date, time, access key, or other information that may provide insight as to when or how the portfolios were accessed or viewed. A portfolio display module 136 displays a personal portfolio at a computing device. In an exemplary embodiment, portfolio display module 136 enables the presentation of a portfolio at a referred user computer in response to receipt of an access key. Portfolio display module 136 may also enable the presentation of a portfolio at a user computer. For example, the user may review the content, arrangement, and layout of information included in the portfolio at the user computer.

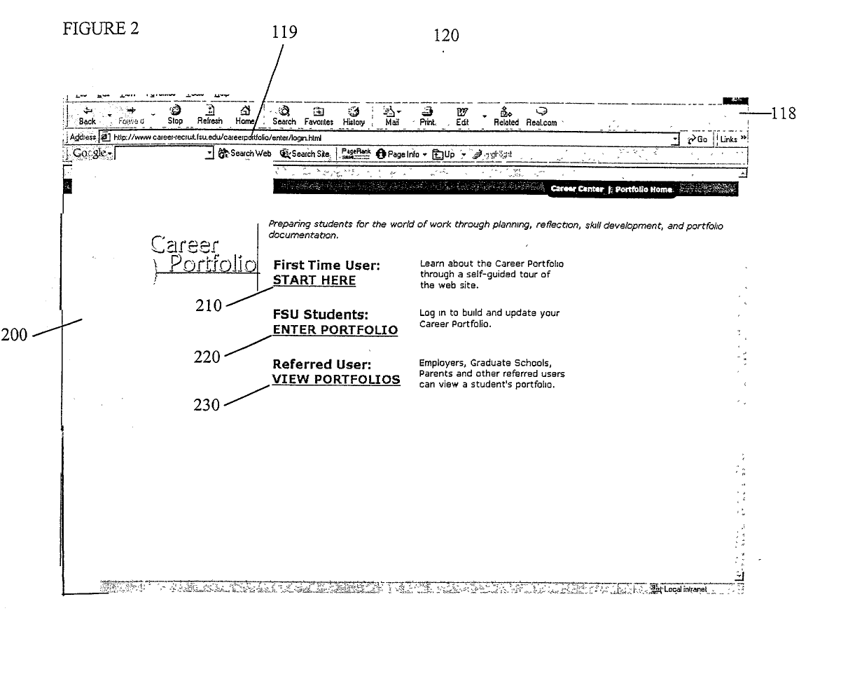

The use of portfolio module 124 will now be described with reference to FIGS. 2-19. In an exemplary embodiment, portfolio module 124 is accessed by a user over an Internet or network connection. FIG. 2 shows a web browser or browser 118 that may be displayed at a computer or computing device such as user computer 110 or referred user computer 140. Browser 118 includes a variety of elements that enable viewing and navigation of Internet web pages and the like, and that allow for entry or modification of information. Web pages may be accessed by entering an address or Uniform Resource Locator (URL) 119 in an address field 120. Any of a variety of browsers may be used with portfolio creation and management system 100, and may include one or more plug-ins or applets configured to provide access to a variety of different audio and video elements that may be included in various web pages.

As shown in FIG. 2, a home or introduction page 200 is displayed in browser 118 when portfolio module 124 is accessed by a user or referred user. Home page 200 includes a variety of hyperlinks or links 210, 220, 230, the number or characteristics of which may differ in alternative embodiments. The hyperlinks may be selected to access another page or screen included in portfolio module 124 or to perform any of a variety of functions provided by portfolio module 124. When another page or screen is accessed by selecting a hyperlink, the new page becomes the current page displayed by the browser. Alternatively, the new page may exist in a separate browser window. As shown, home page 200 includes three hyperlinks 210, 220, and 230 configured to direct the user to various related pages.

New user hyperlink 210 is configured to direct a user to a page including information for first-time users of portfolio module 124, including information relating to the use, operation, or functions of portfolio module 124. User hyperlink 220 is configured to direct a user to a page for current users of portfolio module 124 (i.e., users that create and manage one or more personal portfolios using portfolio module 124). Referred user hyperlink 230 is configured to direct a user to a page for third parties that have been referred by a user.

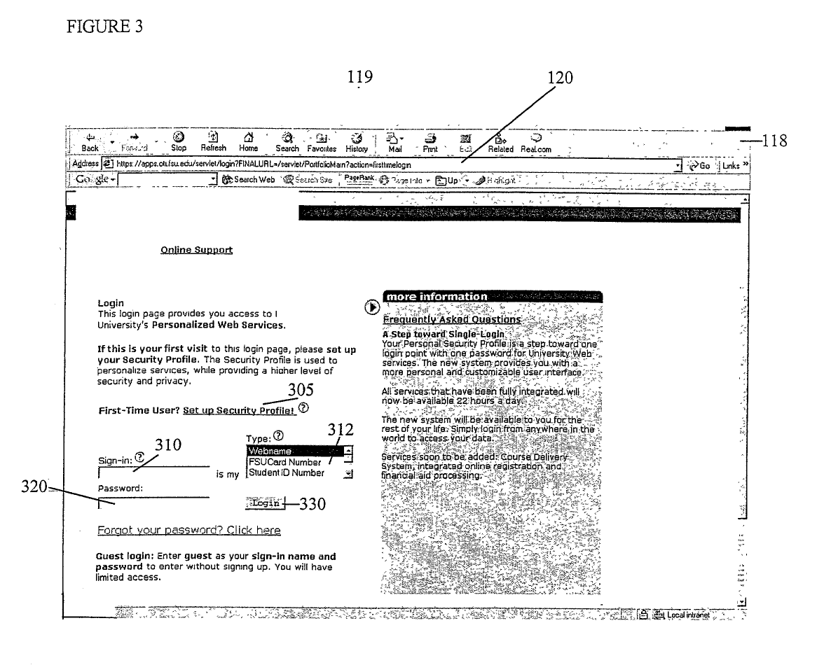

FIG. 3 illustrates a login page or screen 300 that is displayed in response to selection of user hyperlink 220. If a user has not previously used portfolio module 124 or has not created a security profile, the user may select security profile hyperlink 305 to create a user security profile. A security profile serves to provide a secure method of providing access to information included in portfolio module 124.

One or more fields 310, 312, 320 are provided in login page 300 for entering identification information. Sign-in or login field 310 includes a space for the user to enter sign-in or login information for the user (as will be described further below). In an exemplary embodiment, a user may select the type of sign-in information that is entered in field 310 by selecting one of the items listed in sign-in type field 312. For example, a user may select “student ID number” from the list included in sign-in type field 312. The user then enters his or her student identification number in field 310. A password associated with the sign-in information may then be entered in password field 310. Once the user has entered sign-in information in sign-in field 310 and a password in password field 320, login button 330 may be selected, after which the system examines stored user identification information to determine if the user identification information provided corresponds to user identification information included in the system. If the user identification information corresponds to user identification information included in portfolio module 124, the user may access the various components of portfolio module 124. If there is no correspondence, access is denied.

Sign-in or login and password information may be created for or by the user upon selection of security profile hyperlink 305. For example, the user may create a sign-in code that corresponds to the user's student identification number, and then may create a password associated with that sign-in code. The password may include any number of alphanumeric characters, symbols, or the like. In an exemplary embodiment, a variety of sign-in information may be associated with a single password. For example, a user may enter a web name, a social security number, a student identification number, and/or other information. The user may then create a single password. When a user then logs onto the system, the user may select a type of sign-in information from sign-in type field 312 and may enter the corresponding sign-in information in sign-in field 310. The password may be entered in password field 320. The same password may be used regardless of the type of sign-in information selected by the user.

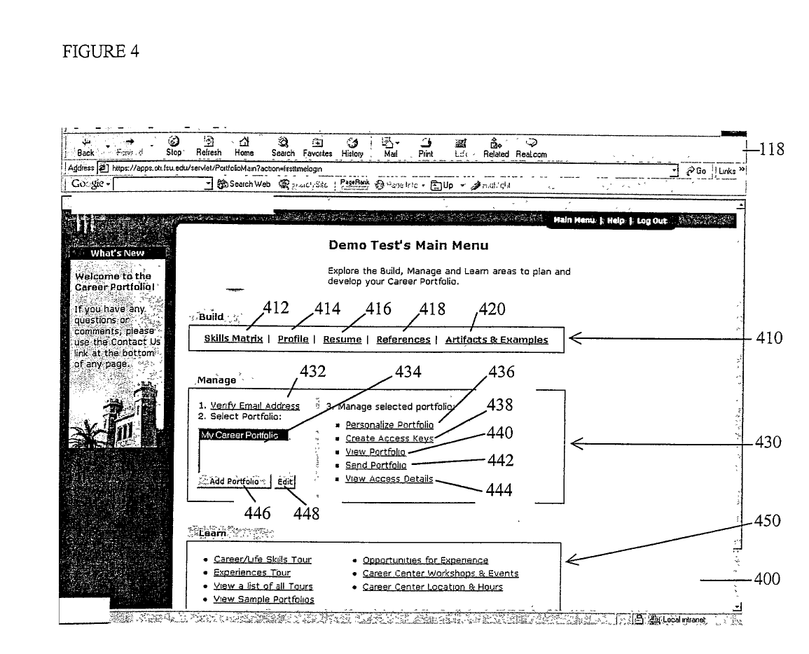

Referring now to FIG. 4, a user having access to portfolio module 124 is presented with a main menu page or screen 400. Main menu page 400 includes one or more menus 410, 430, 450 that each include various hyperlinks or links configured to allow a user to access various aspects or components of portfolio module 124.

A portfolio information entry menu 410 includes hyperlinks that are configured to direct a user to other pages or screens allowing entry of portfolio information into database 126. This information may later be used to create one or more personal portfolios. In an exemplary embodiment, portfolio information entry menu 410 includes a skills and experience summary hyperlink 412, a user profile hyperlink 414, a resumé hyperlink 416, a references hyperlink 418, and an artifacts and examples hyperlink 420. The pages corresponding to skills and experience summary hyperlink 412 and artifacts and examples hyperlink 420 are described below in detail. The page corresponding to user profile hyperlink 414 allows a user to enter a brief profile for the user.

The user profile may include a general summary of the user, the user's goals, relevant experiences or accomplishments, and the like. The profile may be the first item displayed upon accessing a personal portfolio. Alternatively, a different item may be displayed first upon accessing a personal portfolio, and the profile may or may not be included in the portfolio. In an exemplary embodiment, the page corresponding to user profile hyperlink 414 includes one or more fields configured to allow entry of text by the user. The page may also include a field for entering an identification or name for the profile. The page corresponding to resumé hyperlink 416 is configured to allow a user to enter and update a personal resume or biography that may be included in a portfolio. For example, a user may “upload” an electronic file including a resumé as part of the portfolio information included in database 126. The page corresponding to references hyperlink 418 is configured to allow a user to add names, addresses, phone numbers, electronic mail (e-mail) addresses, and/or other information for individuals who may act as references for the user.

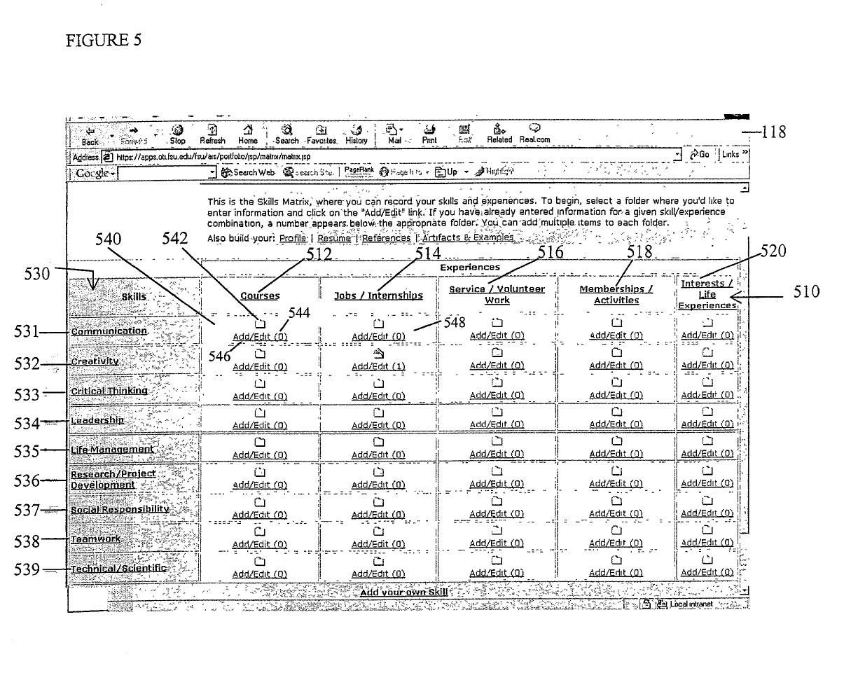

FIG. 5 illustrates a skills and experience summary page 500 provided by skills assessment or analysis module 132 when a user selects skills summary hyperlink 412. Skills assessment module 132 is in electronic or data communication with both information input module 131 and database 126 to provide a summary of personal accomplishment, experience, or skill information. As shown, skills and experience summary page 500 is presented as a skills matrix or summary 505. Skills matrix 505 advantageously allows a user to review and assess the user's various experience or accomplishment information included in database 126 in relation to a variety of skills, goals, characteristics, and/or attributes. As shown in the exemplary embodiment of FIG. 5, skills matrix 505 includes a horizontal axis 510 and a vertical axis 530. Each of horizontal axis 510 and vertical access 530 include a number of headings or categories.

Vertical axis 530 includes a list of headings related to skills or attributes. Other headings may also be included, for example, headings related to characteristics, goals, or other factors a user may wish to assess in relation to the user's experiences. As shown, vertical axis 530 includes headings for communication 531, creativity 532, critical thinking 533, leadership 534, life management 535, research and product development 536, social responsibility 537, teamwork 538, and technical and scientific ability 539. In an exemplary embodiment, headings included in vertical axis 530 are hyperlinks that may direct a user to information relating to the particular heading (e.g., examples, definitions, etc.).

In an exemplary embodiment, vertical axis 530 includes a list of nine headings, and a tenth heading may be added by a user. The tenth, user-defined heading is displayed as the last heading in vertical axis 530, and may relate to the other nine headings or may be independent of them. In an alternative embodiment, additional customization of headings included in the vertical axis may be provided. For example, a user may create more than one new heading and add it to the list of existing headings. In another example, headings included in the vertical axis may be replaced with different headings or rearranged. Thus, in alternative embodiments, users may add, modify, rearrange, or remove headings included in the vertical axis. As an example, a user may desire vertical axis headings that relate to steps or stages leading to the accomplishment of a particular goal or target. For example, a student who is majoring in education may have a goal of being certified in a variety of teaching areas. The student may then customize the vertical axis headings to reflect the various teaching areas (e.g., special education, elementary education, secondary education, administration, etc.).

Horizontal axis 510 includes a list of headings related to various types of experiences, accomplishments, and the like. As shown in FIG. 5, horizontal axis 510 includes headings related to courses 512, jobs or employment and internships 514, service and volunteer work 516, memberships and activities 518, and interests and life experiences 520. In an exemplary embodiment, the horizontal axis headings are static or unchangeable (e.g., not modifiable by a user). In an alternative embodiment, horizontal axis headings may be added, modified, rearranged, or removed by the user.

A number of cells are included in matrix 505, with each cell corresponding to the intersection of a particular column and row heading. For example, cell 540 in FIG. 5 is formed at the leftmost column and the topmost row of skills matrix 505. The corresponding vertical axis heading is “communication,” while the corresponding horizontal axis heading is “courses.” Thus, cell 540 represents portfolio information relating to courses taken that have some relationship to the skill of communication. In this manner, cell 548 located to the right of cell 540 may represent jobs or internships having some relationship to the skill of communication.

While the exemplary embodiment of FIG. 5 shows a grid having a plurality of cells, any of a variety of other graphical presentations may be used to summarize or present portfolio information. For example, a skills and experience summary page may include a list of skills, and a number of experience categories (e.g., courses, jobs, etc.) for each of the skills. One advantageous feature of the skills matrix page shown in FIG. 5 is that comparisons may be made between various skills and experiences in a simple and efficient manner.

Cell 540 includes an icon or graphic indicator 542, a quantity indicator 544, and an information entry hyperlink 546. In an exemplary embodiment, icon 542 may resemble a file folder. Where no portfolio information is included in database 126 for a given cell (e.g., in cell 540, no information relating to courses having some relationship to the skill of communication is included in database 126), icon 542 may be presented as a closed file folder. When information is included in database 126 for a given cell, icon 542 may be presented as an open folder having papers or other material contained therein.

Quantity indicator 544 represents the amount of portfolio information included in database 126 corresponding to a given cell. For example, if two courses having some relationship to the skill of communication are included, quantity indicator 544 would be presented as the number “2”. It should be noted that the indicators displayed in the various cells in grid 505 may differ in alternative embodiments. For example, in an alternative embodiment, a cell may include an icon different from a file folder, or may include no icon at all. In another exemplary embodiment, the quantity indicator may be replaced by another representation of the amount of portfolio information. For example, the cell may be color-coded based on the amount of information (e.g., red indicating no information, yellow indicating some information, and green indicating sufficient information). Any of a variety of other indicators may also be provided in the cells.

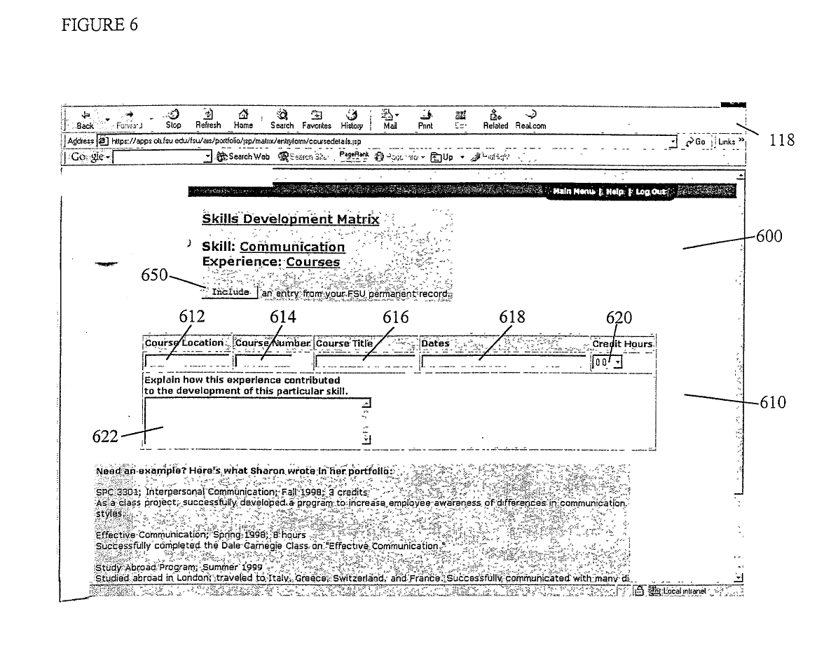

Selecting information entry hyperlink 546 allows a user to add or edit portfolio information corresponding to cell 540. In this manner, information entry hyperlink 546 provides a direct link to information input module 131. Upon selecting information entry hyperlink 546, the user is presented with a course information entry page 600, as shown in FIG. 6. A user may enter information in one or more of course location field 612 (e.g., school, campus, or other location at which the course was taken), course number field 614, course title field 616, dates attended field 618, credit hours field 620, and free text field 622. Free text field 622 allows entry of information describing the relevance of the class to the particular skill, or may include any other information the user deems important. The information entered is automatically associated with cell 540, and quantity indicator 544 is presented as the number “1”. If additional course information is entered for cell 540, quantity indicator 544 changes accordingly. Depending on which cell information entry hyperlink 546 is selected in, the page presented to the user may differ. For example, the information entry screen for cell 540 may include fields that differ from those for cell 548. In alternative embodiments, information entry hyperlink 546 may be a button, field, or other similar element configured to allow access of information input module 131. One advantageous feature of including an information entry hyperlink in each individual cell of the grid is that information entered is automatically associated with a particular cell (e.g. a particular skill and a particular experience type). Information entered into database 126 is then automatically categorized according to the corresponding skill and experience type, such that when the skills and experience summary page is presented, indicators included in each cell indicates the amount of portfolio information included in the database corresponding to each cell.

Information input module 132 may include a course input module 137. Course input module 137 may include an interface with an institutional records database that includes historical information related to transcript information, enrollment information, course description information, awards information, employment information, resumé information, project information, and other relevant information that may be stored in an institutional database.

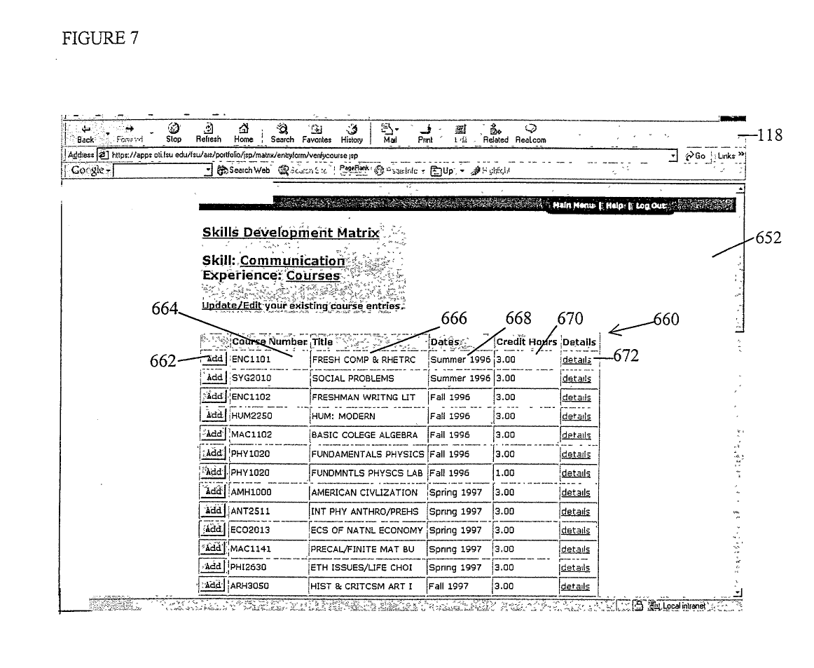

In the exemplary embodiment shown in FIGS. 6 and 7, the institutional database is a course record database comprising information related to a user's past educational courses. As an alternative to manual entry of course information as shown in FIG. 6, entries from a user's electronic course record may be selected and automatically input into database 126 by selecting a course record button 650. FIG. 7 shows a course record or history page 652. Information relating to one or more courses taken by the user is included in a course table 660. As shown in FIG. 7, course information is arranged in rows, with entries related to course number 664, course title 666, attendance dates 668, credit hours 670, and details 672. Other arrangements of course information are possible (e.g., course information may be arranged in columns, in a list, etc.). Information for a particular course may be added to database 126 by selecting an add course button 662 in the left column of the relevant row. Course information is then automatically added to database 126 as corresponding to cell 540, with details 672 corresponding to information that may be added manually in free text field 622.

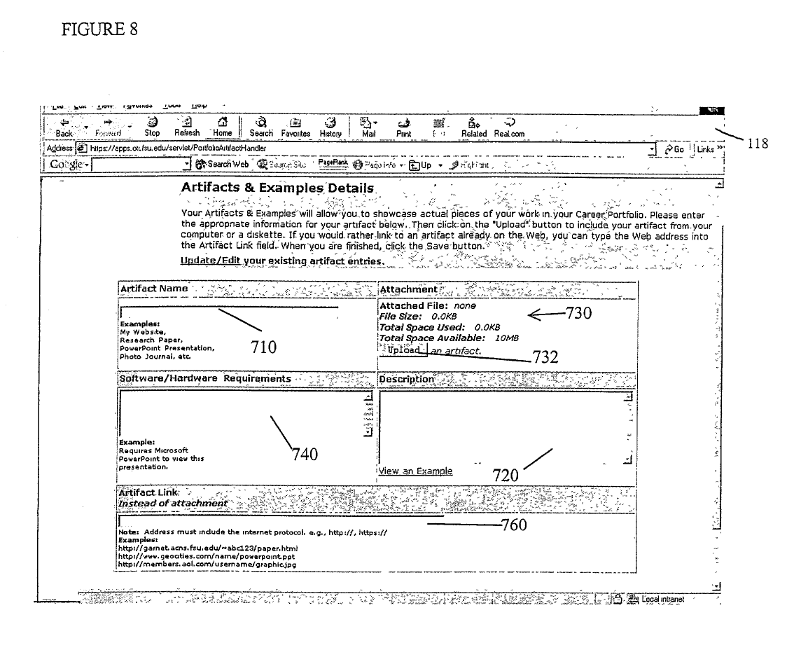

Any of a variety of artifacts and/or examples may also be included in database 126. Selecting artifacts and examples hyperlink 420 in portfolio information entry menu 410 (FIG. 4) takes the user to artifacts and examples page 700 shown in FIG. 8. Electronic files (e.g., text, spreadsheet, presentation, graphics, video, audio, etc.), web page locations or URLs, and other information may be included in this manner.

Artifact name field 710 allows a user to provide a name for a particular artifact or file being included in database 126. For example, if a user includes a research paper as an artifact, the name “Research Paper” could be entered in artifact name field 710. A description of the artifact may be included in description field 720. For example, the user could input a summary of the purpose and findings of the research paper in the above example. If the artifact is an electronic file, the file may be attached to or inserted in the portfolio in attachment field 730. Selecting upload document button 732 may present a user with a list of all available files that may be selected for inclusion in database 126. For example, the list may be in the form of a file or directory tree listing all files included in user computer 110 or stored in another computing device or location. Information relating to the size of the file may be presented in attachment field 730. The user may also enter any software or hardware requirements for viewing the artifact in requirements field 740. As an alternative to including an entire electronic file in the portfolio, the user may instead insert a hyperlink to a file stored in another location by entering a URL or web address into one or more URL entry fields 760. For instance, if the artifact is the user's web page, the URL for that web page may be entered in a URL entry field, such that the referred user may select the URL in the portfolio and will be directed to the web page. In an alternative embodiment, another field may be provided in which a user may enter a URL or other file location. In this alternative embodiment, the URL or file location may correspond to the location of a graphic that may be included in a portfolio, for example, a graphic representative of the artifact such as a screen shot, photograph, image, or the like.

Returning now to FIG. 4, main menu 400 includes a portfolio creation and customization menu 430. Portfolio creation and customization menu 430 allows the user to select or change features using portfolio creation module 133. Portfolio creation module 133 advantageously allows a user to create and/or customize one or more personal portfolios including at least a portion of the portfolio information (e.g., experience information, profiles, resumes, references, etc.).

In an exemplary embodiment, portfolio creation and customization menu 430 includes an e-mail address hyperlink 432, a portfolio customization hyperlink 436, an access key creation hyperlink 438, a portfolio viewing hyperlink 440, a portfolio referral hyperlink 442, and an access detail hyperlink 444. Also included in menu 430 is a portfolio selection menu 434, which lists the names of one or more portfolios created by the user. By selecting the name of one of the portfolios, the user may manage or customize various aspects of the portfolio. For example, where a user selects “My Career Portfolio” from portfolio selection menu 434, the user may create one or more access keys for that portfolio by selecting the access key creation hyperlink 438. Additionally, the user may add new portfolio names or edit the names of existing portfolios by selecting buttons 446 or 448, respectively.

Pages corresponding to the portfolio customization hyperlink 436, access key creation hyperlink 438, portfolio viewing hyperlink 440, a portfolio referral hyperlink 442, and access detail hyperlink 444 are described below in detail. The page corresponding to e-mail address hyperlink 432 is configured to allow a user to select an e-mail address that is associated with the various portfolios created. When a user creates an access key corresponding to the portfolio (as will be described in greater detail below), the access key may include the e-mail address as part of the access key. For example, where the access key is a Uniform Resource Locator (URL), a portion of the URL may be the e-mail address provided by the user. In an alternative embodiment, a different e-mail address may be associated with each of the portfolios.

The page corresponding to portfolio referral hyperlink 442 is configured to allow a user to send an access key to a referred user. For example, after creating an access key for a given portfolio, the user may wish to provide the access key to a potential employer so that the employer may view the portfolio. The access key may be sent to the referred user in any of a variety of ways. In an exemplary embodiment, the access key may be sent in an electronic mail message.

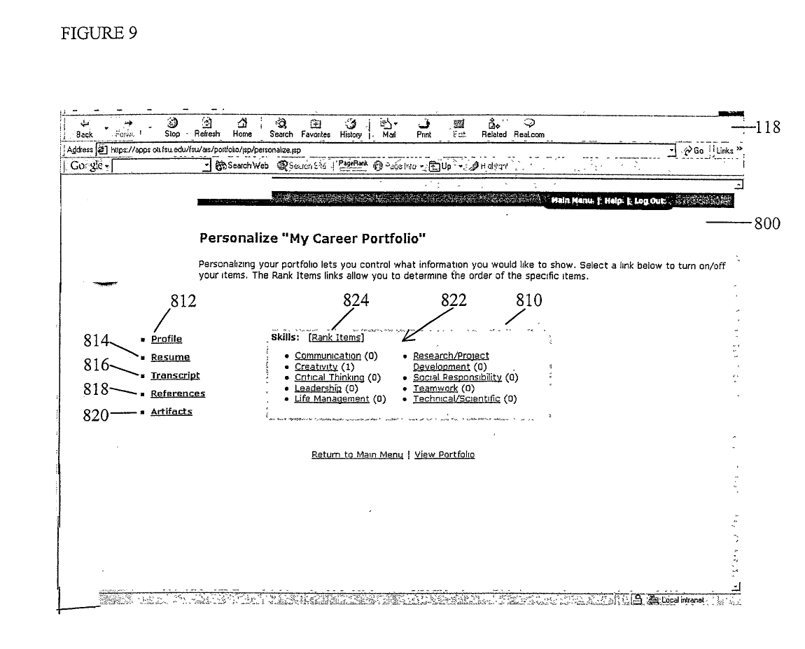

After selecting the name of a particular portfolio in portfolio selection menu 434 and selecting customization hyperlink 436, the user is presented with portfolio customization page 800, shown in FIG. 9. Using portfolio customization page 800, the user may choose the portfolio information that is included in a particular portfolio and how that information is presented (i.e., the arrangement or layout of the information).

A portfolio customization menu 810 includes a variety of hyperlinks corresponding to various customization options. For example, a profile hyperlink 812 directs a user to a page configured to allow the user to modify a personal profile included in a portfolio. For example, the user may be presented with a list of information included in a profile with check boxes next to each piece of information. The user may then select or deselect various information to include or exclude the information from the profile, respectively. Information included in the user profile may be re-ordered by choosing a profile rank hyperlink 813. The user may also modify other information included in a portfolio, such as by selecting resumé hyperlink 814, transcript hyperlink 816, references hyperlink 818, and/or artifacts hyperlink 820. Selecting resumé hyperlink 814 allows a user to select or deselect a resumé included in database 126. In this manner, the user may select one of a variety of resumes for inclusion in a portfolio. Selecting transcript hyperlink 816 allows a user to select or deselect an option to include a transcript in a portfolio. Selecting references hyperlink 818 or artifacts hyperlink 820 allows a user to select the references and artifacts that are included with the portfolio, and selecting the corresponding rank references hyperlink 817 and rank artifacts hyperlink 819 allows a user to determine the order in which the references and/or artifacts are presented in the portfolio.

The process of including, excluding, modifying, and re-ordering information presented in a portfolio may be described with reference to the customization of skills information in FIGS. 9-11. Skills corresponding to vertical axis headings described above with regard to skills and experience summary page 500 (FIG. 5) are included in portfolio customization menu 810 as skill or attribute hyperlinks 822.

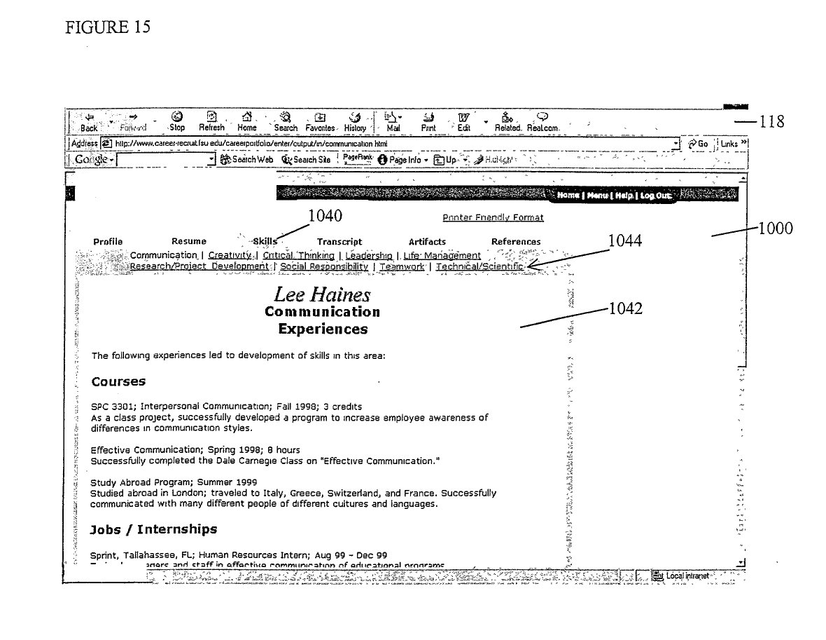

The skills listed in vertical axis 530 may be re-ordered for presentation in a particular portfolio by selecting skills rank hyperlink 824. For example, a user may wish to emphasize particular skills in a portfolio. While the skills are presented in a particular, fixed order in the skills matrix, the user's various experiences may be presented in list form in a portfolio (see, e.g., FIG. 15) organized by skill. Thus, the skills, and hence the experience information corresponding to the skills, may be rearranged according to a user's preferences.

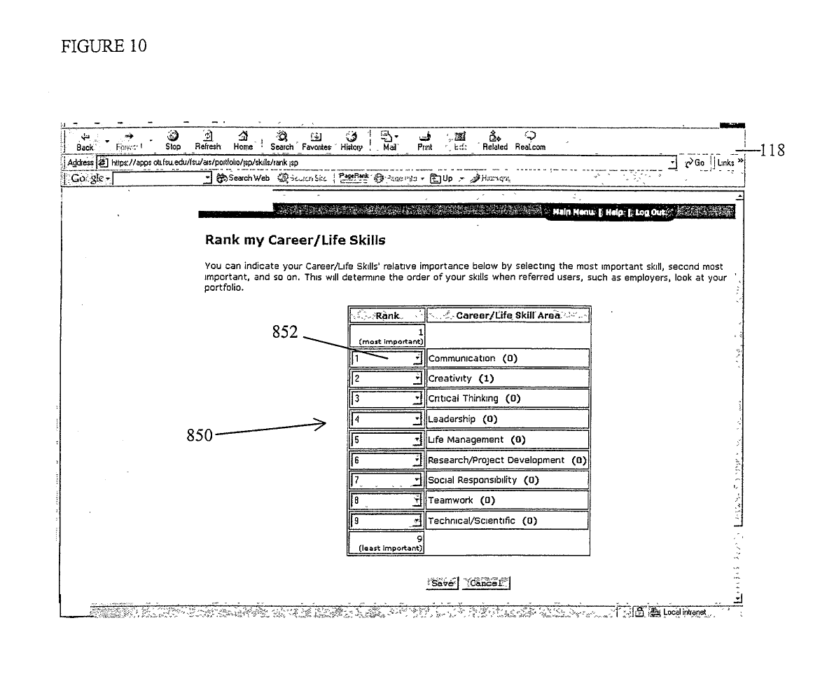

Upon selection of skills rank hyperlink 824, the user is presented with a skill ranking page 850 (FIG. 10). Skill ranking page 850 (FIG. 10) includes one or more drop-down or pull-down menus 852 for selecting a position for a given skill. For example, numbers listed in the pull-down menus may be arranged to correspond to the order in which the skills are presented in the portfolio. For example, if a particular job requires critical thinking and leadership skills, the “critical thinking” and “leadership” skills could be arranged to be the first and second items listed in vertical axis 530. In an exemplary embodiment, only skills for which information has been entered into the database are displayed in the skills ranking page. For example, if no experience information corresponding to the skill of “communication” has been entered using the skills matrix, “communication” is not be displayed in the list of skills in skills ranking page 850. In an alternative embodiment, skills may be ranked despite the lack of information corresponding to that skill in the database.

A similar ranking page may be used to rank other portfolio information, including the profile, references, artifacts, and the like. While skill ranking page 850 is shown as having drop-down menus 852 corresponding to the variety of skills, other methods of ranking the skills to be included in a portfolio may also be provided. For example, the numbers to the left of the skills may be provided in a pull-down menu, such that the skills listed on skill ranking page 850 remain static while the adjacent numbers may be changed to reflect the desired order of the skills.

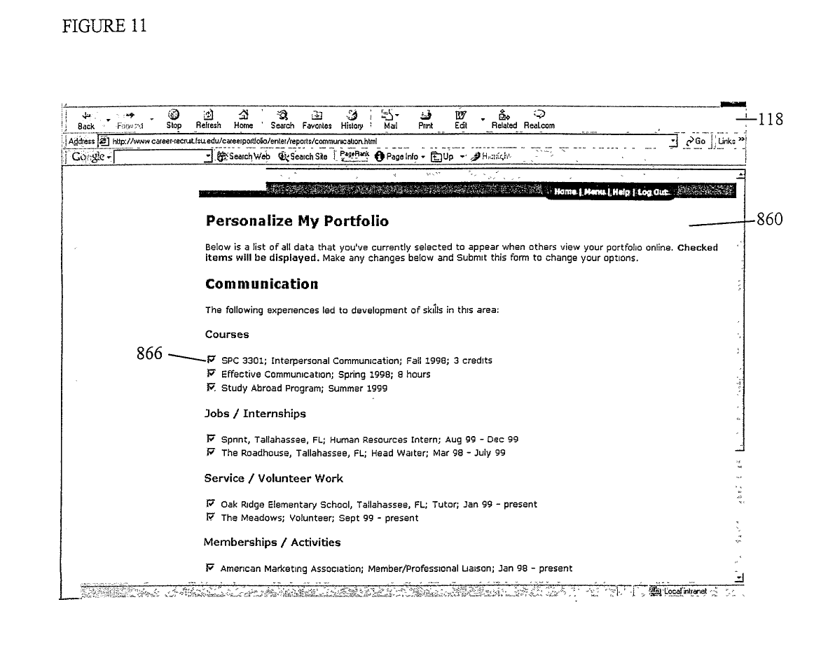

To further customize information presented in a particular portfolio, each of skill or goal hyperlinks 822 may be selected to modify the information available for each skill or attribute. FIG. 11 shows a skills information selection page 860, in which information entered at skill and experience summary page 500 is presented in list form for the particular skill or goal selected. In the example shown in FIG. 11, all information entered corresponding to “communication” is listed for each of the various experience or accomplishment types or categories. Check boxes 866 are provided next to each entry, and may be selected (shown as a check mark in a box) or deselected (shown as an empty box) to include or exclude the item from the portfolio, respectively. While the method of selecting or deselecting particular items is illustrated as using check boxes, other methods may also be used. Selected information is presented in a skills and experience summary page, while deselected information is not presented.

Once the user has customized the portfolio, the user may create access keys or codes for referred users. In this manner, the user may present customized portfolios to various third parties. For example, if a first employer would like to review a user's portfolio, the user may tailor or customize information included in a first portfolio and provide the first employer with access to the first portfolio. A second employer may have different needs or desires, and a second portfolio may be customized for the second employer.

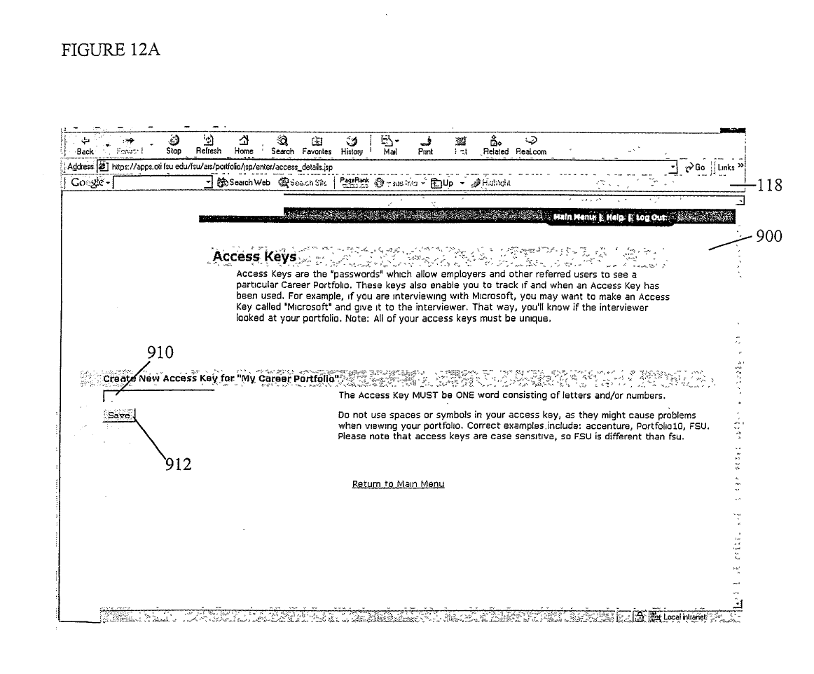

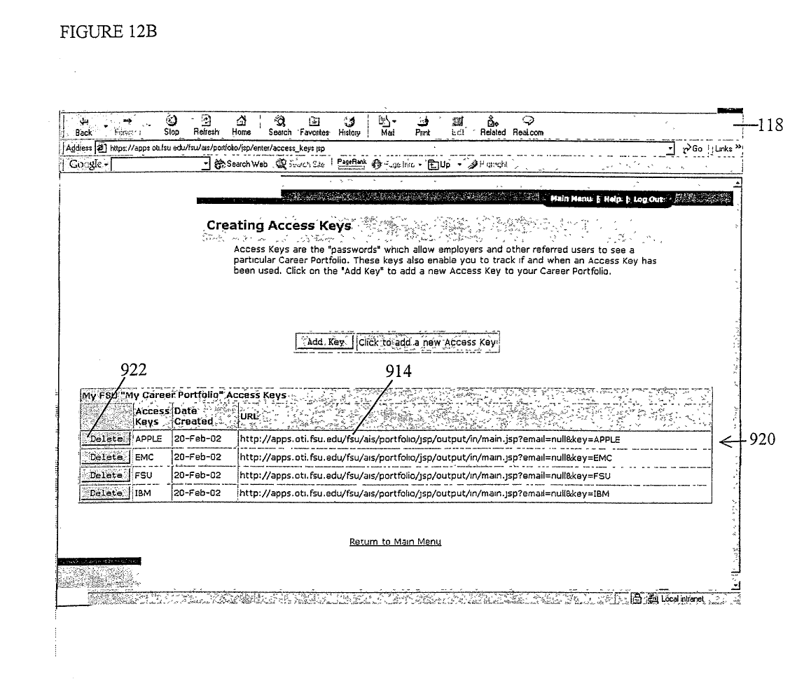

FIGS. 12A and 12B show an access key creation page 900 that is displayed upon selection of access key creation hyperlink 438 in portfolio customization menu 810 by the user. A new access key or code may be created by entering alphanumeric characters and/or symbols in an access key or code name field 910. For example, to create an access key for XYZ Corporation, the user may enter “XYZ” in access key name field 910. Information entered in access key name field 910 may be chosen by the user, and need not necessarily correspond to the name of the third party or referred user to which the access key is provided. For example, a user may enter “portfolio 1 ” in access key name field, and then may provide access to more than one referred user. The access key name may be a company name, user name, an identification code, or the like. Portfolio module 124 automatically generates an access key 914 upon submission of the information entered in access key name field 910 when button 912 is selected. In an exemplary embodiment, access keys may be URLs or web addresses. In this embodiment, the URL may be given to a third party, such that when the third party types the URL into a web browser, the third party is presented with the portfolio. The URL may include an e-mail address provided by a user (e.g., http://portfolio.school.edu/view.cfm?id=bob@school.edu&key=XYZ, where bob@ school.edu is the email address and XYZ is the access key name). In alternative embodiments, other types of access keys may be created. For example, a third party or referred user may be provided with a user e-mail address and an access key name. When the referred user selects hyperlink 230 at home page 200, the referred user may be presented with an access screen. The access screen may include a first field in which the e-mail address may be entered and a second field in which the access key name may be entered. Upon entering this information, the referred user would then be presented with the corresponding user portfolio, in the same manner as if the referred user were given a URL including this information.

An access key table 920 is provided for displaying each of the access keys 914 corresponding to a particular portfolio. Information entered in access key name field 910, the date the access key was created, and the complete access key 914 (shown as a URL) may be presented in access key table 920. A delete button 922 may also be provided next to each access key 914 to remove the access key 914 from the portfolio. Selecting a delete button disables the corresponding access key 914, such that access key 914 does not provide a referred user with access to the portfolio. In this manner, outdated access keys may be removed.

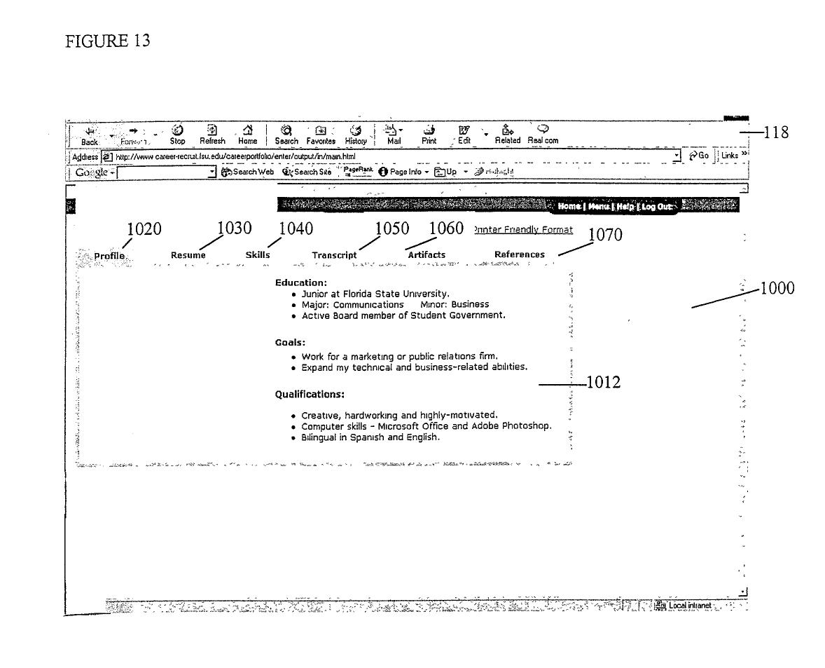

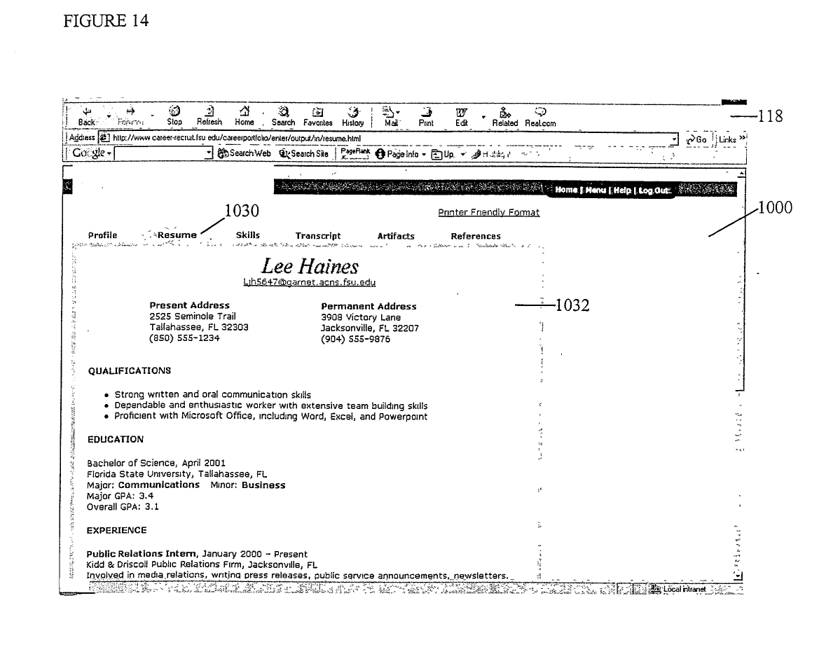

FIG. 13 shows a portfolio viewing page 1000 presented to a referred user. Portfolio viewing page 1000 includes a display area 1012 and one or more tabs 1014 corresponding to information available in the portfolio. Portfolio viewing page 1000 is configured to allow a third party to select and view a particular type of portfolio information by selecting one or more of tabs 1014. As shown in FIG. 14, a user profile tab 1020, resume tab 1030, skills tab 1030, transcript tab 1050, artifacts tab 1060, and references tab 1070 are included in portfolio viewing page 1000.

In an exemplary embodiment, tabs are included only where a portfolio includes information corresponding to the tab. For example, where a resume is not included in a portfolio, resume tab 1030 is not displayed to a referred user. This advantageously may direct attention away from an omission from a portfolio (i.e., a referred user is not presented with a blank display upon selecting a tab, which may highlight a shortcoming of the user's portfolio). In an alternative embodiment, a tab may displayed even where no information is included in the portfolio corresponding to the tab.

Selecting a tab causes information to be displayed in display area 1012. As shown in FIG. 13, profile information is shown in display area 1012 because profile tab 1020 has been selected. Other tabs may be selected to display different information, as shown in FIGS. 14-18.

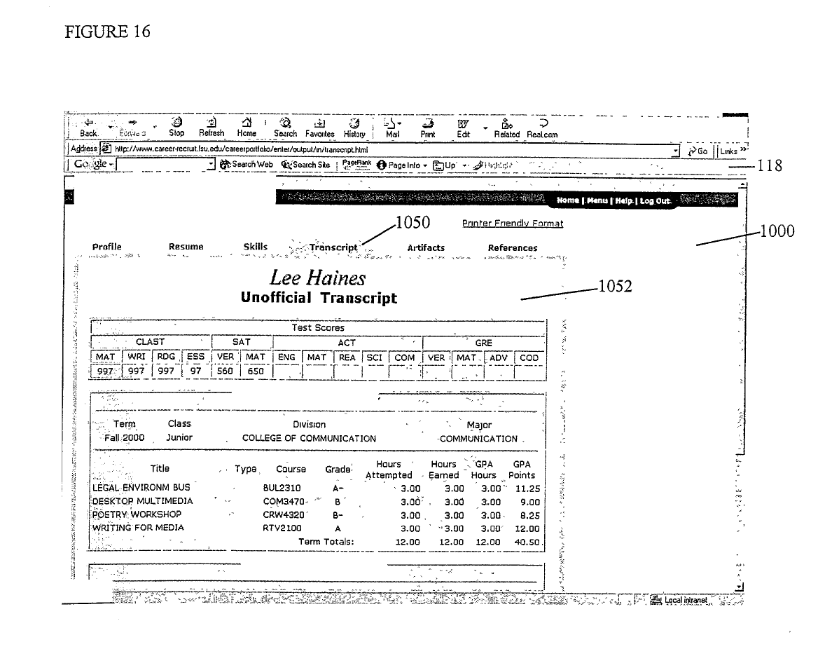

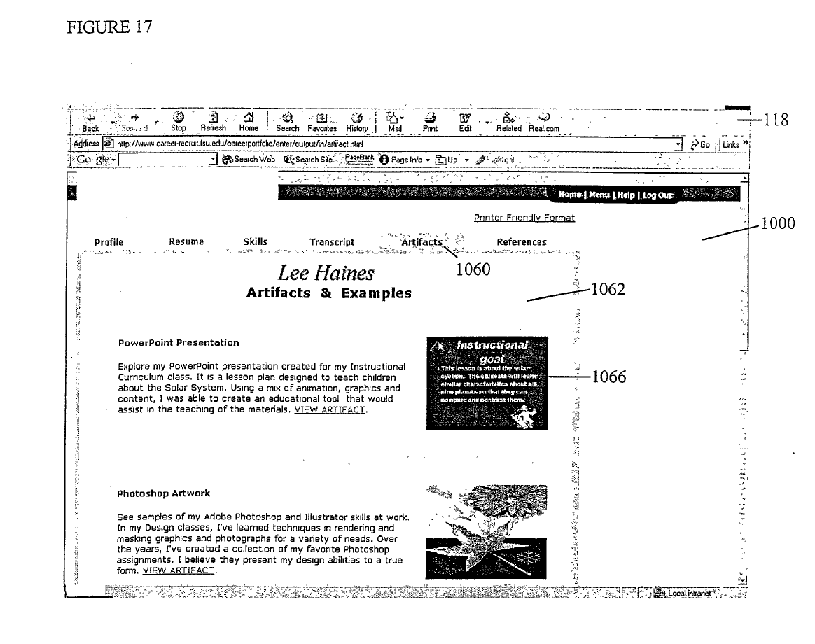

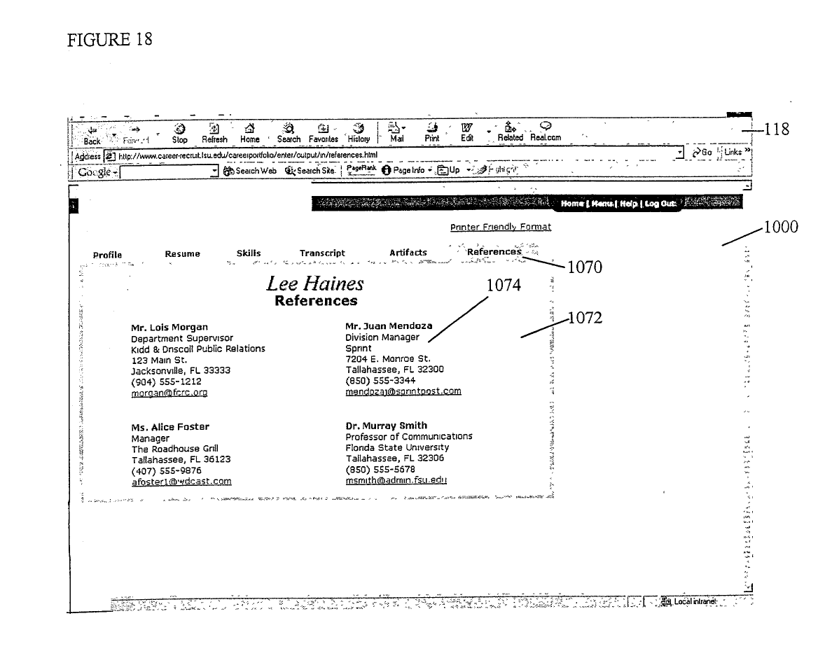

FIG. 14 shows a resumé page 1032 displayed when resumé tab 1030 is selected. FIG. 15 shows an experience or accomplishment list 1042 that is displayed upon selection of skills tab 1040. Information included in experience and accomplishments list 1042 is arranged by skill or attribute. Hyperlinks 1044 are provided to allow a viewer to jump to a particular skill or attribute displayed in list 1042. FIG. 16 shows a transcript page 1052 displayed upon selection of transcript tab 1050. FIG. 17 shows an artifacts and examples page 1062 displayed in response to selection of artifacts and examples tab 1060. Artifacts and examples page 1062 may include descriptions 1064 of the artifacts. In the exemplary embodiment shown, a graphic 1066 corresponding to an artifact is included to provide a visual example of the artifact. In alternative embodiments, graphics are not included for artifacts. Other information may also be provided, such as a hyperlink, an electronic file, and the like. FIG. 18 shows a references page 1072 displayed in response to the selection of references tab 1070. One or more references 1074 may be included in references page 1072.

In an exemplary embodiment, certain headings or other information displayed for a particular tab will only be included where there is information associated with that heading in the portfolio. For example, a particular skill or attribute will only be included in experience list 1042 if there is information included in the portfolio associated with that skill or attribute. Where a user has deselected all information associated with the skill of “communication,” the heading for “communication” is not included in experience list 1042.

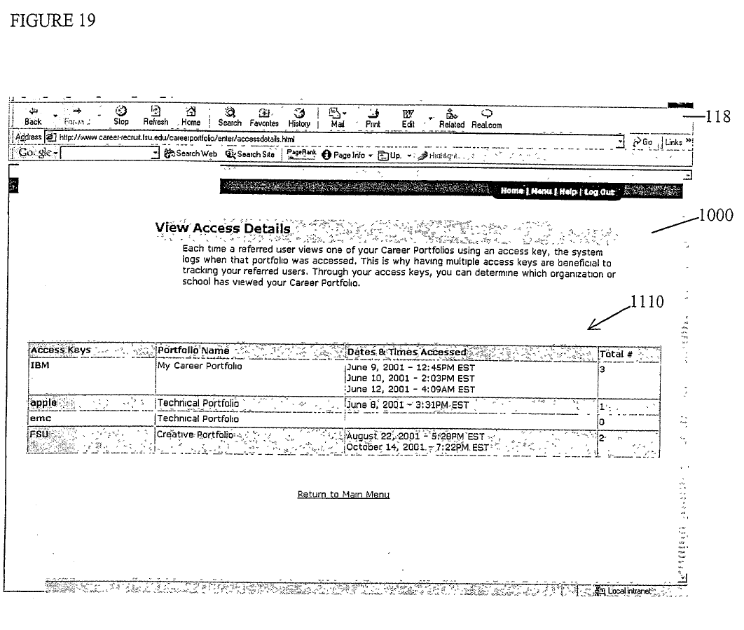

Referring to FIGS. 4 and 19, a user may track referred user access or viewing of one or more portfolios created by the user. At portfolio creation and customization menu 430, the user may select access detail hyperlink 444, after which the user is presented with access detail page 1100 (FIG. 19). An access detail table 1110 includes information relating to access or viewing of the one or more user portfolios. In this manner, users may track referred user activities.

In the exemplary embodiment shown in FIG. 19, information relating to the access key name, portfolio name, date and time of access, and number of accesses or viewings are included in access detail table 1110. The information included in access detail table may differ in alternative embodiments. For example, information concerning the duration of the access, the type of information viewed by the referred user, and other useful information may be provided. Additionally, information included in access detail table 1110 may be arranged in any of a variety of ways. As shown in FIG. 19, access information is arranged by access key name. In an alternative embodiment, the access information may be arranged by portfolio name, such that the user may easily determine which access key names have been used to view a particular portfolio.

Main menu 400 (FIG. 4) also includes an information and instruction menu 450. Instruction menu 450 may include hyperlinks to pages configured to provide information to the user that may be helpful in creating and managing a portfolio. For example, instruction menu 450 may include a hyperlink to sample portfolios, a list of various experiences that are available to the user, instructions on how to use the portfolio module, and any of a variety of other informational or instructional information.

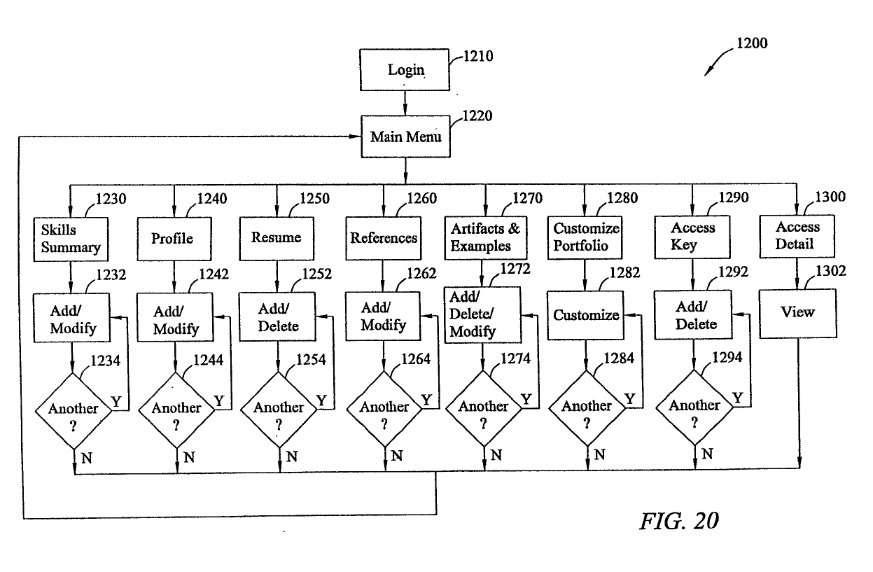

An exemplary method 1200 of using portfolio module 124 will now be described with respect to FIG. 20. FIG. 20 represents one method by which a user may create and manage one or more portfolios using portfolio module 124. A user accesses or logs in to portfolio module 124 at box 1210 by providing a login or sign-in name and a password. After logging in, the user is presented with a main menu at box 1220. The user may choose any of a variety of options from the main menu that allow the user to view, create, and/or modify portfolio information, portfolios, or other information. Example options include a skills summary (box 1230), a user profile (box 1240), a user resume (box 1250), references (box 1260), artifacts and examples (box 1270), portfolio customization (box 1280), access key creation (box 1290), and access detail (box 1300).

If a user selects a skills and experience summary hyperlink, a summary of the portfolio information included in a database, such as a skills matrix, is displayed at box 1230. The user may then add or modify portfolio information included in a portfolio database at box 1232. In an exemplary embodiment, an add/edit hyperlink included in a cell of a skills matrix may be selected to allow a user to add portfolio information to the database that corresponds to the cell. In this manner, the portfolio information added to the database may be automatically associated with a particular skill or attribute and experience or accomplishment type. Once information has been added or modified, the user may choose to add or edit additional portfolio information at box 1234 or may return to the main menu.

If at the main menu the user selects a profile hyperlink, the user is presented with a user profile page at box 1240. The user may then add information to or modify information included in a personal profile at box 1242. Once information has been added to or modified in a personal profile, the user may choose to add or edit another profile at box 1244 or return to the main menu.

If at the main menu the user selects a resumé hyperlink, the user is presented with a resumé page at box 1250. The user may then include or exclude from the portfolio resumés included in the database at box 1252. The user may then choose to add or delete another resumé at box 1254 or return to the main menu.

If at the main menu the user selects a references hyperlink, the user is presented with a references page at box 1260. The user may then add or modify information for a given reference at box 1262 or may add or delete references. The user may then choose to add or modify additional reference information at box 1264, or return to the main menu.

If at the main menu the user selects an artifacts and examples hyperlink, the user is presented with an artifacts and examples page at box 1270. The user may then add, modify, or delete artifacts or information relating to artifacts at box 1272. The user may then choose to add, modify, or delete additional artifact information at box 1274 or may return to the main menu.

If at the main menu the user selects a portfolio customization hyperlink, the user is presented with a portfolio customization page at box 1280. A particular portfolio may be customized by including, excluding, or re-ordering any of a variety of portfolio information at box 1282. For example, the user may select or deselect information included for a particular skill in an experience list presented as part of the portfolio. The user may also alter the order in which the skills are presented. For example, the user may wish to highlight or emphasize certain skills, and may thus re-order the skills such that those skills are presented first in the experience list. Other portfolio information may be selected or deselected or re-ordered as well. For example, a user may choose to include only certain artifacts with the portfolio and may arrange these artifacts in any appropriate manner. When the user is finished selecting, deselecting, or re-ordering information for the portfolio, the user may choose to customize another portfolio at box 1284 or may return to the main menu.

If at the main menu the user selects an access key creation hyperlink, the user is presented with an access key creation page at box 1290. The user may add or delete access keys for the portfolio at box 1292. The portfolio module may automatically generate access keys upon entry of an access key name by a user. The user may then choose to add or delete additional access keys at box 1294 or may return to the main menu.

If at the main menu the user selects an access detail hyperlink, the user is presented with an access detail page at box 1300. The user may then view information relating to the access of one or more portfolios by third parties using access keys. This information may be arranged in any of a variety of ways. After the user is finished viewing the access detail page, the user may return to the main menu.

It should be noted that the above steps may be performed in any order by a user, and some steps may be omitted entirely. Any or all of the hyperlinks included in the main menu may be selected by a user, and the selected hyperlinks may be selected in any order. Thus, for example, after logging in, a user may create an access key for a particular third party and modify a particular portfolio without performing any additional steps such as adding new information to the skills matrix or viewing access details.

Various features and steps disclosed herein may be altered without departing from the spirit and scope of the invention disclosed herein. For example, while the systems and methods disclosed herein have been described in the context of generating a career portfolio, other types of portfolios may also be produced using the systems and methods described. In another example, the various modules included in the system may be included in a single program or module or may exist as separate modules that interact with other modules. Further, one or more of the modules may be included in a computing device or component separate from the server.

While portfolio module 124 has been described as being provided in a server computer, any of a variety of arrangements may be used. In an exemplary embodiment, artifacts are stored in a first data repository, such as a Microsoft SQL database in a Windows® NT server. Other information (e.g., course information, employment information, and other experience information, etc.) are stored in a second data repository, such as an Oracle database on a UNIX server. A third server may be provided to act as a web applications server, from which the various modules may run. The various modules may retrieve information from one or both of the first and second servers in generating and/or displaying a personal portfolio. Program extensions may be configured to run from a web browser included in a personal computer. Each of the three servers and personal computer are in data communication (e.g., an Internet, intranet, network, or other connection).

In alternative embodiments, the portfolio module or components or portions thereof may be provided at locations other than the server. In one embodiment, all or a portion of the portfolio module may be provided at a user computer. For example, a program may be installed on a user computer that includes various functions or features included in the portfolio module, such as allowing a user to create and modify portfolios, analyze portfolio information, and/or create one or more access keys. The database that stores portfolio information may therefore be located at a user computer, at a server, or at another location. The user may create and store a portfolio at the user computer and upload or communicate the portfolio to a server. In this manner, the amount of information stored at the server may be reduced, and the user may not be required to maintain a connection to a server during use of the portfolio module. Alternatively, the portfolio may be created in a server computer using information stored on a user computer. Additionally, the portfolio information may or may not be communicated to a server. For example, the user computer may include all components of the portfolio module, such that a referred user may communicate directly with the user computer to view one or more portfolios. Any of a variety of configurations are possible, as one of skill in the art will readily understand.

In another alternative embodiment, rather than communicating portfolio information to a server over an Internet connection, a user may communicate this information over a network connection (e.g., a LAN, WAN, etc.). For example, the user may use a user computer that is in communication with a file server included in the same local network. The user may communicate portfolio information to a file server included in the network, without the need for a separate Internet connection. Similarly, a referred user may view one or more portfolios over a network connection rather than an Internet connection where the referred user computer connected to the network that includes the various portfolios. In another example, the user may communicate information over a network while the referred user views portfolios over an Internet connection, or vice versa.

In a further alternative embodiment, more than one server may be used, such that various components of the portfolio module are located in a variety of locations. For example, a database for storing portfolio information may be provided in a first server while other components of a portfolio module may be provided in a second server. In another example, a user computer may provide certain functions of a server, such as storing portfolio information, storing created portfolios, or providing any of a variety of other features of a portfolio module (e.g., creating portfolios, providing a summary of portfolio information, etc.).

Although the present invention has been described with reference to certain exemplary embodiments, those skilled in the art who review this disclosure will readily appreciate that many modifications are possible without materially departing from the novel teachings and advantages of the subject matter recited in the claims. Accordingly, all such modifications are intended to be included within the scope of the present invention as defined in the appended claims. Although certain embodiments may have been described as including one or more features providing one or more benefits, it is contemplated that the described features may be interchanged with one another or alternatively be combined with one another in the described exemplary embodiments or in other alternative embodiments. Unless specifically otherwise noted, the claims reciting a single particular element also encompass a plurality of such particular elements. The order or sequence of any process or method steps may be varied or re-sequenced according to alternative embodiments. Other substitutions, modifications, changes, and omissions may be made in the design, operating conditions, and arrangement of the exemplary and alternative embodiments without departing from the spirit of the present invention as expressed in the appended claims.

What is claimed is:

1. A system for presenting and analyzing personal accomplishments in an electronic environment, the system comprising:
a database storing personal accomplishment information; and
a skills analysis module in communication with the database and configured to provide a summary of the personal accomplishment information;
wherein the summary comprises a list including a plurality of personal attributes and a summary of the personal accomplishment information corresponding to each of the personal attributes.

2. The system of claim 1, further comprising an information entry module in communication with the skills analysis module and the database, the information entry module configured to allow entry of personal accomplishment information into the database.

3. The system of claim 2, wherein the summary includes means for accessing the information entry module.

4. The system of claim 3, wherein the means for accessing the information entry module includes at least one of a hyperlink, a button, and a field.

5. The system of claim 1, wherein the personal accomplishment information includes information selected from course information, employment information, internship information, volunteer information, membership information, activity information, interest information, hobby information, and life experiences information.

6. The system of claim 1, wherein the personal attributes include at least one of communication, creativity, critical thinking, leadership, life management, social responsibility, teamwork, technical, research, and project development skills.

7. The system of claim 1, wherein the summary also includes a list of personal accomplishment types and a summary of the personal accomplishment information corresponding to each of the personal accomplishment types.

8. The system of claim 7, wherein the personal accomplishment types include at least one of courses, employment, internship, volunteer work, memberships, activities, interests, and hobbies.

9. The system of claim 1, wherein the summary is presented as a skills matrix having a plurality of cells, each of the cells corresponding to a personal attribute and to a personal accomplishment type.

10. The system of claim 9, wherein each cell includes an indicator signaling the presence in the database of personal accomplishment information corresponding to the personal attribute for the cell.

11. The system of claim 10, wherein the indicator is at least one of text, a graphic, a picture, a number, and a color.

12. The system of claim 11, wherein the indicator signals the presence in the database of personal accomplishment information corresponding to the personal accomplishment type for the cell.

13. The system of claim 1, wherein the list of personal attributes includes at least one personal attribute determined by a user.

14. A system for presenting a summary of personal experience information, the system comprising:
an electronic archive storing personal experience information;
an information entry module enabling entry of the personal experience information into the electronic archive; and
a module in communication with the electronic archive presenting a summary of the personal experience information at a display, the summary indicating the presence of personal experience information stored in the electronic archive corresponding to at least one personal attribute.

15. The system of claim 14, wherein the electronic archive comprises a database.

16. The system of claim 14, wherein the module presents the summary in the form of a matrix.

17. The system of claim 16, wherein the matrix includes a plurality of cells, each of the cells corresponding to a personal attribute and to an experience type.

18. The system of 17, wherein each cell includes an icon indicating at least one of the presence and the amount of personal experience information stored in the electronic archive corresponding to the personal attribute and the experience type to which the cell corresponds.

19. The system of 16, wherein the experience type is selected from courses, employment, internship, volunteer work, memberships, activities, interests, and hobbies.

20. The system of claim 14, wherein the personal attribute is selected from communication, creativity, critical thinking, leadership, life management, social responsibility, teamwork, technical, research, and project development skills.

21. The system of claim 14, wherein the summary is presented at a display coupled to a computing device, the computing device being located remote from the electronic archive.

22. The system of claim 14, wherein the module presents the summary at a computing device over an Internet connection.

23. A system for generating a summary of personal experience information, the system comprising:
an information repository configured to retain personal experience information;
means for inputting the personal experience information into the information repository; and
a summary generator in data communication with the information repository for presenting a summary of at least a portion of the personal experience information;
wherein the summary is presented at a computing device as a grid, the grid graphically indicating the presence of experience information in the information repository corresponding to a plurality of personal characteristics.

24. The system of claim 23, wherein the plurality of personal characteristics are selected from communication, creativity, critical thinking, leadership, life management, social responsibility, teamwork, technical, research, and project development skills.

25. The system of claim 23, wherein the information repository comprises an electronic database in data communication with the means for inputting the personal experience information.

26. The system of claim 23, wherein the means for inputting the personal experience information includes an information input module that presents an information entry page at the computing device.

27. The system of claim 26, wherein the information entry page includes at least one field into which information may be entered.

28. The system of claim 23, wherein the grid includes a plurality of cells, each of the cells corresponding to one of a plurality of personal characteristics.

29. The system of claim 28, wherein each of the plurality of cells also corresponds an experience type, and wherein each cell includes an indicator representing an amount of personal experience information retained in the information repository corresponding to the personal characteristic and experience type for the cell.

30. The system of claim 29, wherein each of the plurality of cells also includes an information entry hyperlink, the information entry hyperlink providing access to the means for inputting the personal experience information into the information repository.

31. The system of claim 23, wherein the grid includes a first axis having a plurality of headings representative of personal characteristics and a second axis having a plurality of headings representative of experience types, wherein a grid cell is formed at the intersection of each of the first axis headings and the second axis headings.
